(19) United States
(12) Patent Application Publication
(10) Pub. No.: US 2004/0128123 A1
(43) Pub. Date: Jul. 1, 2004

(54) Quality evaluation equipment of network speaking

(76) Inventor: Kazuhiro Kashiwagi, Tokyo (JP)

Correspondence Address: LEWIS F. GOULD, JR., DUANE MORRIS LLP, ONE LIBERTY PLACE, PHILADELPHIA, PA, 19103, US

(21) Appl. No.: 10/402,871

(22) Filed: Mar. 26, 2003

(30) Foreign Application Priority Data
Dec. 26, 2002 (JP) 2002-375933

(51) Int. Cl. G10L 21/00; G10L 19/00

(52) U.S. Cl. 704/201

(57) ABSTRACT

A speaking terminal 3 connected with a communication network has means for voice speaking 18 for speaking with voice by voice packets through the communication network, and means for measuring and computing speaking quality 15, for measuring and computing evaluation data of speaking quality concerning voice speaking executed by the means for voice speaking 18. And, a network speaking control unit, providing means for collecting evaluation data of speaking quality, for collecting evaluation data of speaking quality measured and computed, is provided, connecting with the speaking terminal 3. Then, the quality of network speaking can be evaluated with a simple structure.

### BACKGROUND OF THE INVENTION

This invention relates to a quality evaluation equipment for conducting quality evaluation of network speaking with a voice packet, and more specifically to a quality evaluation equipment of network speaking, capable of effectively executing arithmetic processing concerning evaluation data of speaking quality without making the structure of the quality evaluation equipment of network speaking complex.

A network speaking for speaking with voice, making use of a communication network, such as the Internet or a dedicated communication network with a development of VoIP (Voice over Internet Protocol) technique has lately been put to practical use. In order to speak with voice in such a network speaking, voice data divided into packets are exchanged between terminals for speaking, thereby the quality of voice speaking may deteriorate by delay, jitter (fluctuation of reaching time) or disappearing in the middle of transfer concerning the packet.

Under this situation, a quality evaluation equipment of network speaking for judging in which state the quality of voice speaking in many speaking terminals is in order to specify the reasons of deterioration of voice quality has been proposed, specifically for a person of communication business or a network manager. Such quality evaluation equipment proposed is that a speaking quality monitoring unit, capable of obtaining data for evaluating speaking quality, such as delay, jitter (fluctuation of reaching time) or disappearing in the middle of transfer concerning a packet, is provided between the communication network and many speaking terminals.

In a communication system 50 wherein a plurality of speaking terminals, such as a computer 3 or an IP telephone 7, are respectively connected with the ports of a switching hub 9 and the switching hub 9 is further connected with the communication network 2 through a server 23, as shown in FIG. 9(a), for instance, there are two types of the quality evaluation equipments, that is, a quality evaluation equipment 1x as shown in FIG. 9(b) wherein a speaking quality monitoring unit 5 is connected with each of the speaking terminals 3, 7, 7, and the quality evaluation equipment 1y as shown in FIG. 9(c) wherein the speaking quality monitoring unit 5 is connected upstream concerning the switching hub 9.

In the quality evaluation equipment 1x of FIG. 9(b) a target voice packet can be easily identified in the speaking quality monitoring unit 5 since the communication information concerning the respective speaking terminals 3, 7, 7 is identified by the switching hub 9. But, the increase of the speaking terminal in its number leads to accordingly increase the speaking quality monitoring unit 5 and a diverging device 27 owing to such a structure that the speaking quality monitoring unit 5 is connected with each speaking terminal. Then, the structure of the quality evaluation equipment is inconveniently made complex.

On the contrary, the structure of the quality evaluation equipment 1y of FIG. 9(c) is easy. Under the environment where many subjects, such as delay, jitter or disappearing in the middle of transfer concerning the packet should be measured, it is necessary to effectively execute arithmetic processing concerning the data for evaluating speaking quality. But, various kinds of communication information is transmitted onto the speaking quality monitoring unit 5 owing to such a structure that the speaking quality monitoring unit 5 is connected upstream concerning the switching hub 9. Although for the above-mentioned reason, the arithmetic processing for identification of the target voice packet from among various kinds of communication information is necessary, the arithmetic processing can not be effectively executed.

Taking the above-mentioned state into consideration, the development of the quality evaluation equipment of the network speaking, capable of effectively conducting arithmetic processing concerning the data for evaluating speaking quality without making the quality evaluation equipment of network speaking complex has been desired.

### SUMMARY OF THE INVENTION

The present invention is quality evaluation equipment of network speaking for evaluating speaking quality of network speaking in network speaking for speaking with voice by exchanging voice packets between a plurality of speaking terminals connected with a communication network through said communication network; comprising:

means for voice speaking for speaking with voice with voice packets through said communication network, and means for measuring and computing speaking quality, for measuring and computing data for evaluating speaking quality concerning said voice speaking (such as, delay of reaching of voice packet 6, jitter, disappearing of voice packet 6, delay, reciprocating delay time, data concerning objective tone evaluation value, or an evaluation value of speaking quality or objective tone computed therefrom) by said means for voice speaking, both provided at a speaking terminal;

a network speaking control unit connected with said speaking terminal; and

said network speaking control unit having means for collecting data for evaluating speaking quality, for collecting data for evaluating speaking quality measured and computed by said means for measuring and computing speaking quality of each said speaking terminal.

According to this invention, the quality evaluation equipment of network speaking is comprised of a speaking terminal connected with a communication network having means for voice speaking for speaking with voice with voice packets through the communication network and means for measuring and computing speaking quality, for measuring and computing data for evaluating speaking quality concerning the voice speaking, and the network speaking control unit connected with the speaking terminal has means for collecting data for evaluating speaking quality, for collecting data for evaluating speaking quality measured and computed. Then, it is not necessary to individually provide the speaking quality monitoring unit (5 as shown in FIGS. 9(b), (c)) for the speaking terminal, as a conventional quality evaluation equipment of network speaking (1x, 1y as shown in FIGS. 9(b), (c)), so that the quality evaluation equipment of network speaking can be made simple.

Besides, the present invention is the quality evaluation equipment of network speaking, wherein said means for measuring and computing speaking quality of each said speaking terminal has means for identifying voice packet, for identifying said voice packet of voice speaking executed by said means for voice speaking from communication information through said communication network, and means for receiving voice packet, for receiving said voice packet identified by said means for identifying voice packet, wherein speaking with voice is executed by said means for voice speaking with said voice packet received from said means for receiving voice packet.

According to this invention, the means for identifying voice packet of the means for measuring and computing speaking quality identifies the voice packet of voice speaking executed by the means for voice speaking, the means for receiving voice packet of the means for measuring and computing speaking quality receives the voice packet identified, and speaking with voice is carried out by the means for voice speaking with the voice packet received. Then, the arithmetic processing for identifying the voice packet is not necessary to be executed by duplication of the means for measuring and computing speaking quality and the means for voice speaking, so that the arithmetic processing concerning the data for evaluating speaking quality can be effectively executed. By doing so, the network speaking control unit smoothly collects the data for evaluating speaking quality and smoothly evaluates the speaking quality of the network speaking.

Besides, the present invention is the quality evaluation equipment of network speaking, wherein a plurality of said speaking terminals (such as 3A, 3B) are connected with said communication network through means for identifying and transmitting communication information, said means for identifying and transmitting communication information has means for identifying communication information, for identifying said communication information concerning each said speaking terminal (such as 3A, 3B) connected with said means for identifying and transmitting communication information from said communication information through said communication network, and means for transmitting communication information, for transmitting said communication information identified by said means for identifying communication information to said corresponding speaking terminal (such as 3A, 3B), wherein said means for identifying voice packet of each said speaking terminal identifies said voice packet of voice speaking to be executed by said means for voice speaking from said communication information transmitted by said means for transmitting communication information connecting said speaking terminal (such as 3A, 3B) therewith.

According to this invention, the means for identifying communication information of the means for identifying and transmitting communication information identifies the communication information concerning each speaking terminal (such as 3A, 3B) from among the communication information through the communication network, and the means for transmitting communication information of the means for identifying and transmitting communication information transmits the communication information identified to the corresponding speaking terminal (such as 3A, 3B). Then, the voice packet (such as 6A, 6B) attaching own IP address thereon, for instance, can be easily identified from among the transmitted communication information by the means for identifying voice packet of the speaking terminal (such as 3A, 3B), so that the arithmetic processing concerning the data for evaluating speaking quality can be further effectively executed.

The present invention is the quality evaluation equipment of network speaking, wherein said network speaking control unit has means for judging quality of network speaking, for computing and judging said speaking quality of network speaking on the basis of said data for evaluating speaking quality collected by said means for collecting data for evaluating speaking quality.

According to this invention, the network speaking control unit computes and judges the speaking quality of network speaking on the basis of the data for evaluating speaking quality collected by the means for collecting data for evaluating speaking quality, so that the speaking quality of network speaking can be properly evaluated.

The present invention is the quality evaluation equipment of network speaking, wherein said network speaking control unit has means for storing data for evaluating speaking quality, for storing said data for evaluating speaking quality collected by said means for collecting data for evaluating speaking quality.

According to this invention, the network speaking control unit has the means for storing data for evaluating speaking quality, for storing data for evaluating speaking quality collected by the means for collecting data for evaluating speaking quality, so that a network manager, for instance, can collectively control the data for evaluating speaking quality collected as data base, and the speaking quality of network speaking can be further smoothly evaluated by the network speaking control unit.

The present invention is the quality evaluation equipment of network speaking, wherein said network speaking control unit can be connected with said speaking terminal (such as 3A, 3B) through a line different from said communication network (such as C1) (according to a state).

According to this invention, the network speaking control unit can be also connected with the speaking terminal (such as 3A, 3B) through the line different from the communication network (such as C1). Then, the data for evaluating speaking quality can be certainly collected from the means for measuring and computing speaking quality of the speaking terminal by the means for collecting data for evaluating speaking quality, irrespective of the congestion state of the communication network, so that the network speaking control unit can further smoothly evaluate the speaking quality of network speaking.

Besides, the present invention is the quality evaluation equipment of network speaking, wherein said network speaking control unit has means for distributing encoded data, for distributing encoded data obtained by encoding said voice data to be used for measurement to each said speaking terminal, wherein said means for measuring and computing speaking quality of each said speaking terminal can compute said data for evaluating speaking quality on the basis of said encoded data distributed by said means for distributing encoded data.

According to this invention, the means for distributing encoded data of the network speaking control unit distributes encoded data obtained by encoding voice data to be used for measurement to each speaking terminal, and the means for measuring and computing speaking quality computes the data for evaluating speaking quality on the basis of the encoded data distributed. Then, it is not necessary to encode the voice data at the time of transmission of voice data between the respective speaking terminals in order to compute the data for evaluating speaking quality, so that the burden on the arithmetic processing by the transmission of the voice data can be decreased.

Besides, the present invention is the quality evaluation equipment of network speaking, wherein said data for evaluating speaking quality includes at least one data of data of jitter, disappearing, delay, reciprocating delay time, objective tone evaluation value concerning said voice packet, to be measured and computed by said means for measuring and computing speaking quality.

According to this invention, the data for evaluating speaking quality includes at least one data of data concerning jitter, disappearing, delay, reciprocating delay time, objective tone evaluation value concerning the voice packet, and the data for evaluating speaking quality can be properly computed by the means for measuring and computing speaking quality of the speaking terminal thereby.

Besides, the present invention is the quality evaluation equipment of network speaking, wherein said network speaking control unit has means for computing speaking quality, for computing evaluation value of speaking quality or objective tone evaluation value concerning each said speaking terminal on the basis of said data (data concerning jitter, disappearing, delay, reciprocating delay time, objective tone evaluation value concerning the voice packet 6) collected by said means for collecting data for evaluating speaking quality.

According to this invention, the means for computing speaking quality of the network speaking control unit computes the value for evaluating speaking quality or the value for evaluating objective tone concerning each speaking terminal on the basis of the data collected by the means for collecting data for evaluating speaking quality. Then, it is not necessary to compute the value for evaluating speaking quality or the value for evaluating objective tone on the speaking terminal side, so that the burden by the arithmetic processing on the speaking terminal can be decreased so as to make the structure of the speaking terminal simple.

The present invention is the quality evaluation equipment of network speaking, wherein said network speaking control unit has means for transmitting data for evaluating speaking quality for transmitting evaluation value of speaking quality or objective tone evaluation value concerning each said speaking terminal computed by said means for computing speaking quality to each said speaking terminal, said speaking terminal has means for producing image for displaying quality, for producing image for displaying quality (such as EPa, EPb) for displaying said evaluation value of speaking quality or said objective tone evaluation value transmitted by said means for transmitting data for evaluating speaking quality, and display means, for displaying said image (such as EPa, EPb) for displaying quality produced by said means for producing image for displaying quality.

According to this invention, the means for transmitting data for evaluating speaking quality of the network speaking control unit transmits the value for evaluating speaking quality or the value for evaluating objective tone concerning each speaking terminal computed by the means for computing speaking quality to each speaking terminal, the means for producing image for displaying quality produces the quality display image (such as EPa, EPb) for displaying the computed value for evaluating speaking quality or the computed value for evaluating objective tone, and the display means displays the produced quality display image (such as EPa, EPb). Then, the burden by the arithmetic processing on the speaking terminal can be decreased so as to smoothly display the quality display image (such as EPa, EPb).

Besides, the present invention is the quality evaluation equipment of network speaking, wherein said means for measuring and computing speaking quality of each said speaking terminal has means for judging speaking quality, for judging speaking quality at the time of speaking on the basis of said data for evaluating speaking quality, and said speaking terminal (such as 3A, 3B) has means for producing image for displaying quality, for producing image displaying quality (such as EPa, EPb) for displaying speaking quality at the time of speaking judged by said means for judging speaking quality, and display means, for displaying image for displaying quality (such as EPa, EPb) produced by said means for producing image for displaying quality.

According to this invention, the means for judging speaking quality of the means for measuring and computing speaking quality judges the speaking quality at the time of speaking on the basis of the data for evaluating speaking quality, the means for producing image for displaying quality produces the image for displaying quality (such as EPa, EPb) for displaying speaking quality at the time of speaking which is judged, and the display means displays the produced quality display image (such as EPa, EPb). Then, a user can acknowledge the speaking quality at the time of speaking with his eyes through the display means, such as a display so as to compare the speaking quality of the voice actually heard and the displayed speaking quality with each other, when the quality of the voice speaking is deteriorated, for instance, therefore, a network manager can effectively specify the reasons on the basis of the comparison of the subjective and objective evaluation results.

Besides, the present invention is the quality evaluation equipment of network speaking, wherein said means for measuring and computing speaking quality of each said speaking terminal has means for decoding voice packet, for decoding said voice packet through said communication network, and said means for measuring and computing speaking quality is provided with said means for voice speaking such that speaking with voice is possible on the basis of said voice packet decoded by said means for decoding voice packet.

According to this invention, the means, for measuring and computing speaking quality of the speaking terminal decodes the voice packet through the communication network, and the means for measuring and computing speaking quality is provided with the means for voice speaking in order to speak with voice on the basis of the decoded voice packet. Then, the arithmetic processing for decoding the voice packet is not necessary to be executed by duplication of the means for measuring and computing speaking quality and the means for voice speaking, and the arithmetic processing concerning the data for evaluating speaking quality can be further effectively executed.

Besides, the present invention is the quality evaluation equipment of network speaking, wherein said means for decoding voice packet has means for absorbing jitter and decoding, for absorbing jitter concerning said voice packet through said communication network and for decoding said voice packet where jitter is absorbed, and said means for measuring and computing speaking quality has means for computing objective tone evaluation value, for computing said objective tone evaluation value on the basis of said voice packet decoded by said means for absorbing jitter and decoding.

According to this invention, the means for absorbing jitter and decoding of the means for decoding voice packet absorbs jitter concerning the voice packet through the communication network and decodes the voice packet wherein jitter is absorbed, and the means for measuring and computing speaking quality computes the objective tone evaluation value on the basis of the voice packet decoded, so that the objective tone evaluation value can be accurately computed and simultaneously computed in the middle of speaking.

### BRIEF DESCRIPTION OF THE DRAWINGS

FIG. 1 is a schematic diagram for showing an example of a quality evaluation equipment of speaking network to which the present invention is applied;

FIG. 2 is a block diagram for showing an example of a computer having a speaking quality measurement portion;

FIG. 3 is a block diagram for showing an example of an IP telephone having the speaking quality measurement portion;

FIG. 4 is a block diagram for showing an example of a network speaking control unit;

FIG. 5 is a schematic diagram for showing the quality evaluation equipment of the speaking network in first and second embodiments;

FIG. 6 is an explanatory drawing of the computer in the first embodiment, (a) is a schematic configuration diagram, and (b) is a schematic block diagram;

FIG. 7 is a drawing for showing an example of a scope on a display, (a) is a drawing for showing an example of a scope displaying quality in the first embodiment, and (b) is a drawing for showing an example of a scope displaying quality in the second embodiment;

FIG. 8 is an explanatory drawing of the computer in the second embodiment, (a) is a schematic configuration diagram, and (b) is a schematic block diagram; and

FIG. 9 is a configuration diagram of the conventional quality evaluation equipment of the speaking network, (a) is a communication system, (b) is the quality evaluation equipment having one speaking quality monitoring unit connected with one speaking terminal, and (c) is the quality evaluation equipment having the speaking quality monitoring unit connected upstream of a switching hub.

### DESCRIPTION OF THE PREFERRED EMBODIMENT

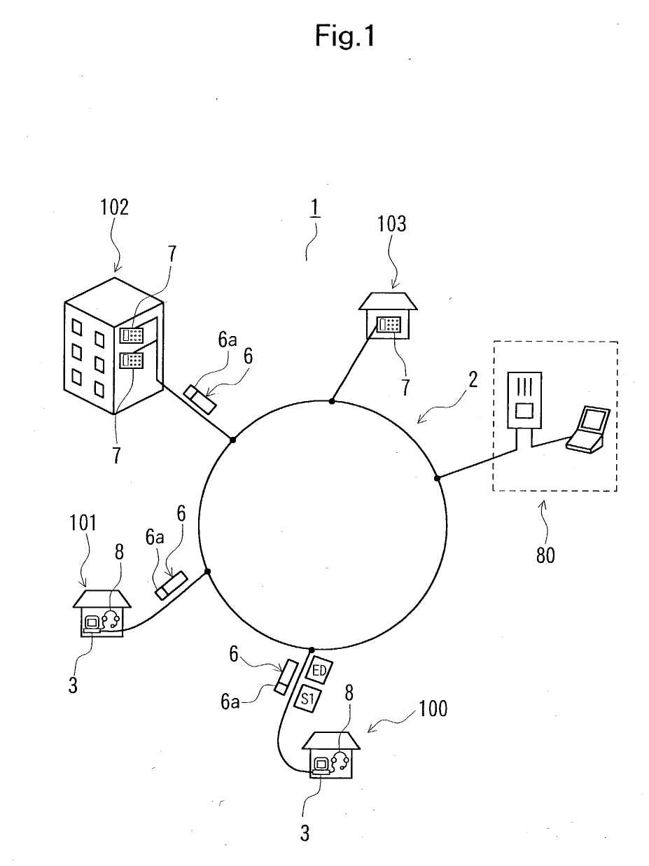

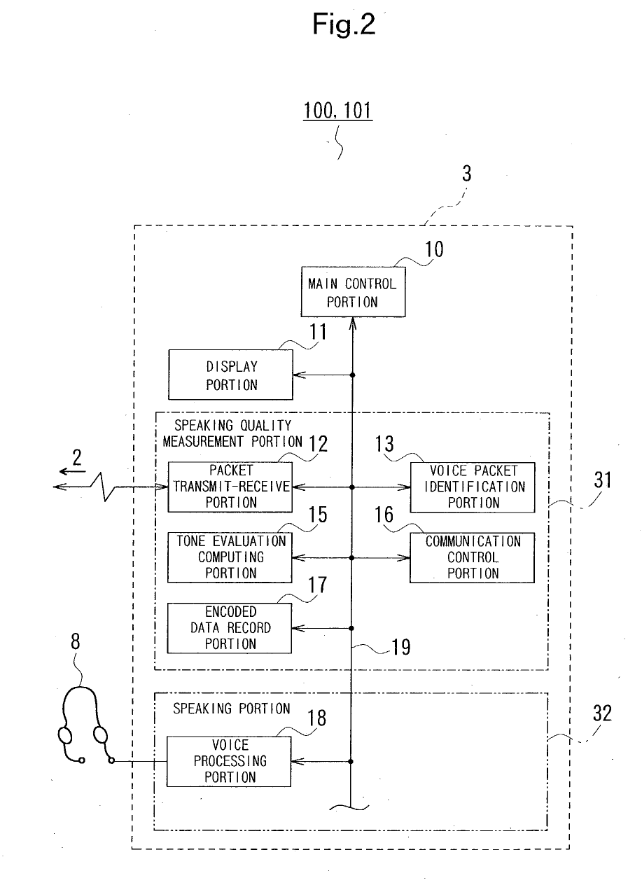

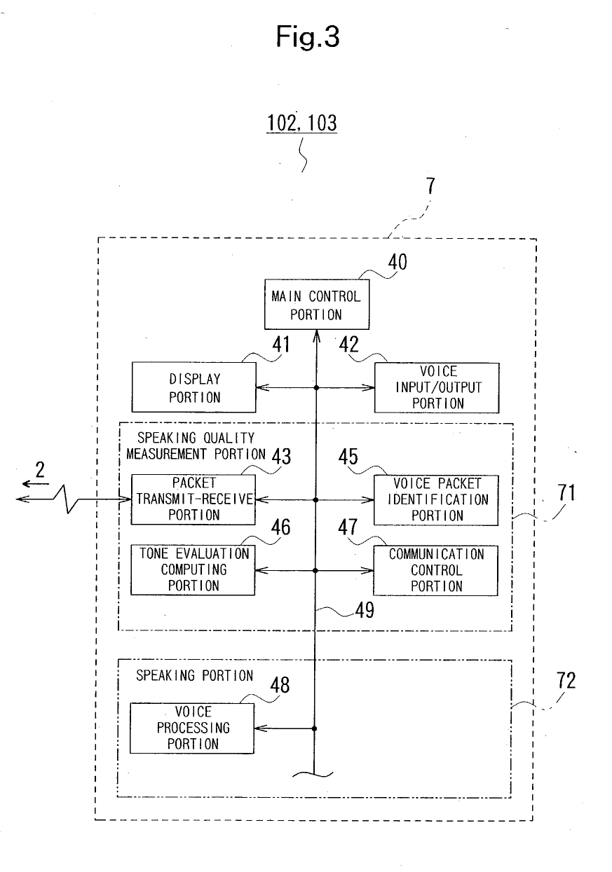

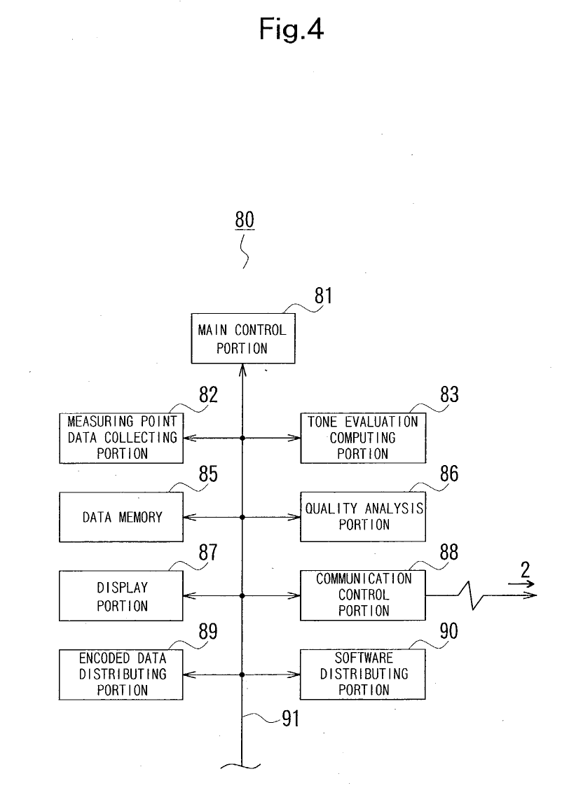

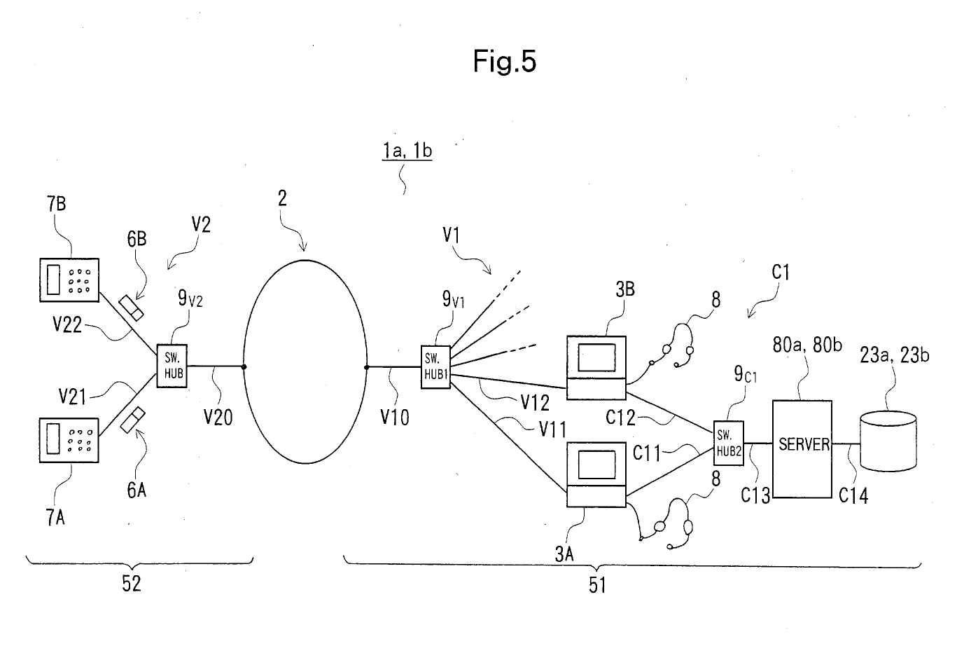

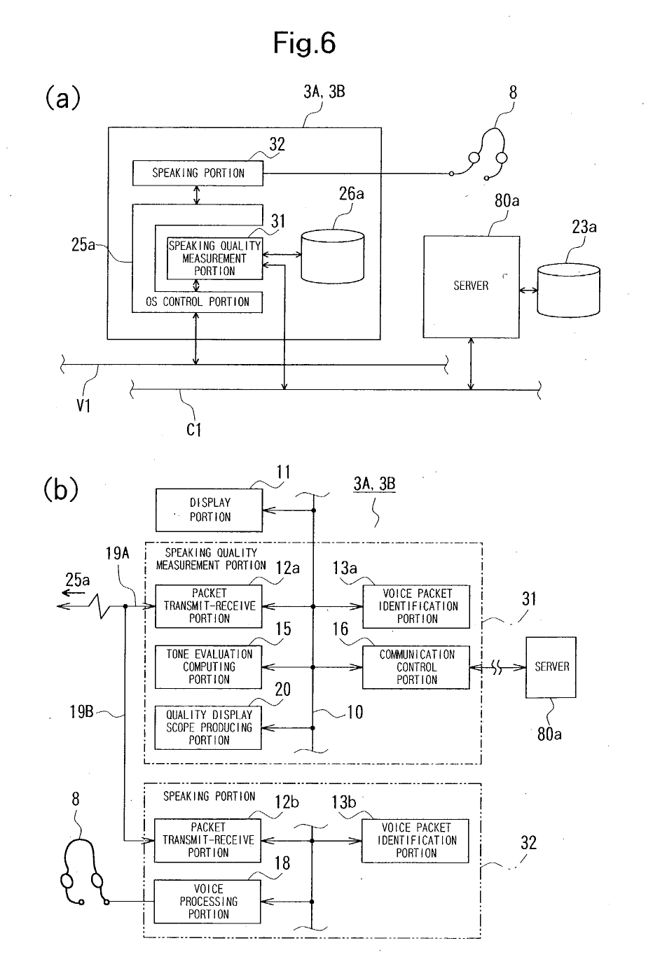

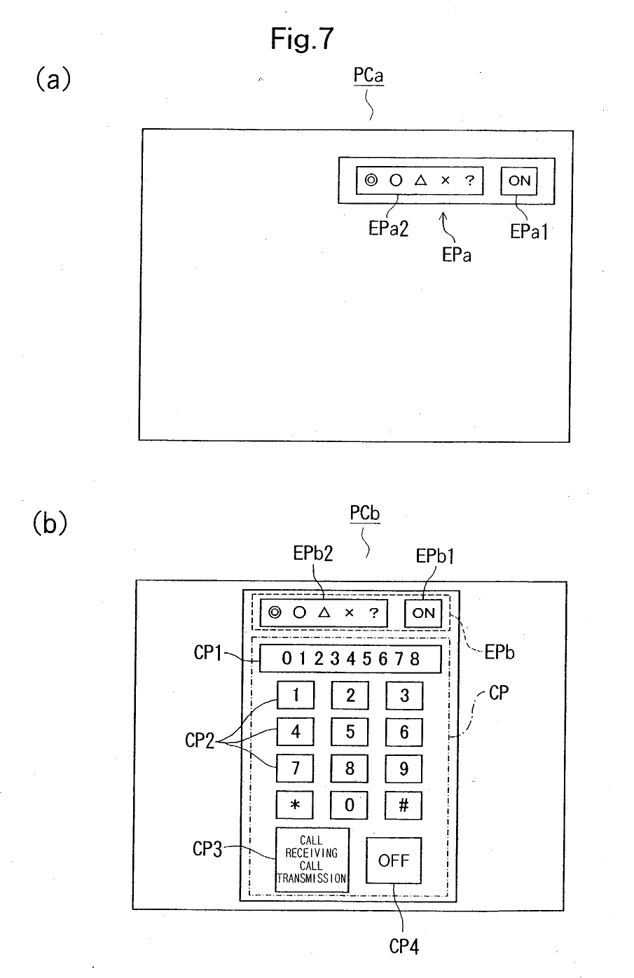

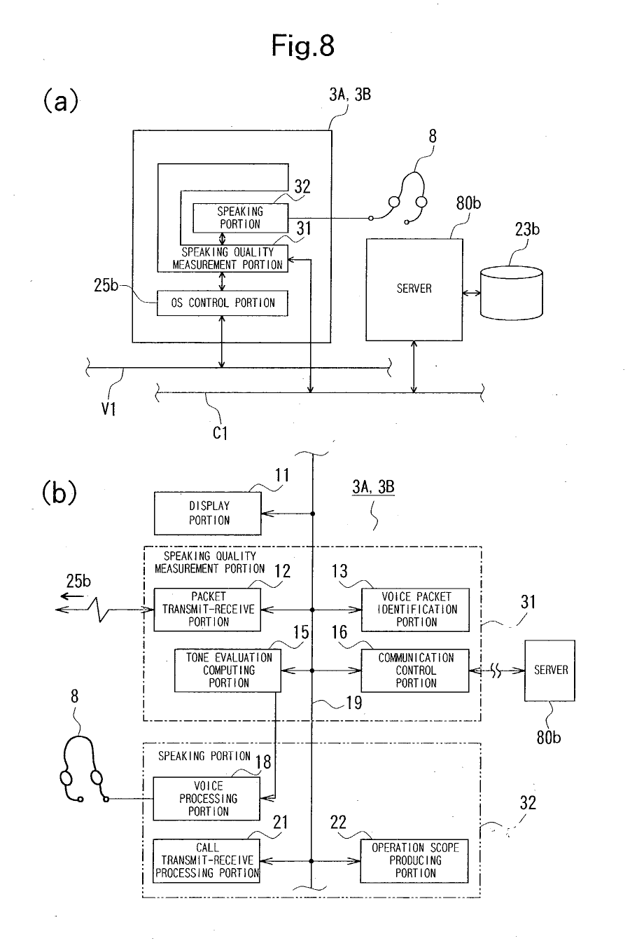

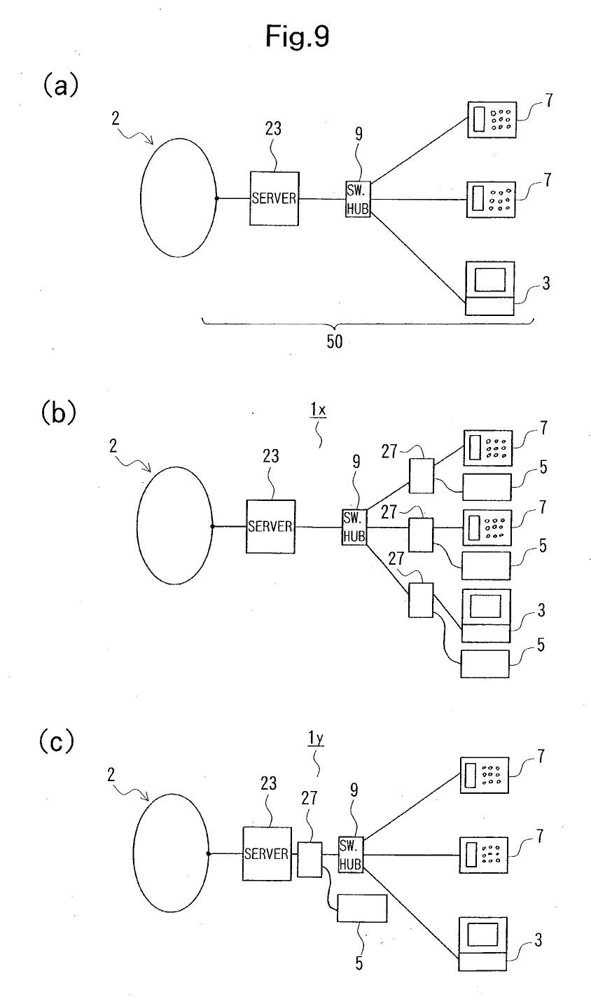

FIG. 1 is a schematic diagram for showing an example of a quality evaluation equipment of speaking network to which the present invention is applied, FIG. 2 is a block diagram for showing an example of a computer having a speaking quality measurement portion, FIG. 3 is a block diagram for showing an example of an IP telephone having the speaking quality measurement portion, FIG. 4 is a block diagram for showing an example of a network speaking control unit, FIG. 5 is a schematic diagram for showing the quality evaluation equipment of the speaking network in first and second embodiments, FIG. 6 is an explanatory drawing of the computer in the first embodiment, (a) is a schematic configuration diagram, and (b) is a schematic block diagram, FIG. 7 is a drawing for showing an example of a scope on a display, (a) is a drawing for showing an example of a scope displaying quality in the first embodiment, and (b) is a drawing for showing an example of a scope displaying quality in the second embodiment, FIG. 8 is an explanatory drawing of the computer in the second embodiment, (a) is a schematic configuration diagram, and (b) is a schematic block diagram, and FIG. 9 is a configuration diagram of the conventional quality evaluation equipment of the speaking network, (a) is a communication system, (b) is the quality evaluation equipment having one speaking quality monitoring unit connected with one speaking terminal, and (c) is the quality evaluation equipment having the speaking quality monitoring unit connected upstream of a switching hub.

As shown in FIG. 1, a quality evaluation equipment of network speaking 1 has a communication network 2 through which packet data communication is conducted by a communication method, such as the Internet protocol. This communication network 2 is a network managed by a specific network manager, which can be used for only a specific member permitted by the network manager, or a public network available for anyone by connecting therewith.

A computer 3 or an IP telephone (Internet protocol telephone) 7 are connected with the communication network 2 as many speaking terminals for speaking with voice by the packet data communication. The computer 3 and the IP telephone 7 are provided in dwelling houses 100, 101, 103 or a multiple dwelling house 102. A connection between the communication network 2 and the computer 3 or the IP telephone 7 may be through a wireless communication, such as a wireless LAN in addition to through a wire communication. In a below-mentioned explanation, the computer 3 and the IP telephone 7 will be referred to as only “speaking terminal 3, 7” if both are not necessary to be differentiated from each other.

The computer 3 has a main control portion 10, as shown inside a frame with a broken line in FIG. 2. A display portion (a display, for instance) 11 and others are connected with the main control portion 10 via a bus line 19. And, the computer 3 functions as a speaking quality measurement portion (a frame with a dashed line) 31 through the bus line 19 by booting a program for measurement for measuring and computing speaking quality evaluation value described hereinafter (referred to as “measuring software S1” hereinafter) by a CPU (not shown), for instance. Furthermore, the computer 3 functions as a speaking portion (a frame with a two-dot chain line) 32 through the bus line 19 by booting a program for speaking (so-called softphone) for actualizing voice speaking by packet data communication.

The speaking quality measurement portion 31 is comprised of a packet transmit-receive portion 12 connected with the communication network 2, a voice packet identification portion 13, a tone evaluation computing portion 15, a communication control portion 16 and an encoded data record portion 17. Besides, the speaking portion 32 is comprised of a voice processing portion 18. A head set 8 comprised of a headphone with microphone is connected with the voice processing portion 18.

On this occasion, various kinds of computers, such as a personal computer, a so-called PDA (personal digital assistant), a UNIX workstation are available as the computer 3. And, any kind of program is available as the program for speaking as long as voice speaking by packet data communication can be realized by the computer 3 through the program, in addition to the softphone above-mentioned, and a program for speaking for realizing a real-time conversation by a plurality of persons (so-called chat) may be also available.

As shown inside a frame with a broken line of FIG. 3, the IP telephone 7 has a main control portion 40, and a display portion (such as a monitor) 41, a voice input/output portion (such as a telephone receiver) 42, a speaking quality measurement portion 71 (a frame with a dashed line), and a speaking portion (a frame with a two-dot chain line) 72 and the like are connected with the main control portion 40 through a bus line 49. Similar to the computer 3, the speaking quality measurement portion 71 is comprised of a packet transmit-receive portion 43 connected with the communication network 2, a voice packet identification portion 45, a tone evaluation computing portion 46 and a communication control portion 47. Besides, the speaking portion 72 is comprised of a voice processing portion 48.

On this occasion, the IP telephone 7 may be a telephone set comprised of a normal telephone set having a dedicated unit (not the IP telephone) for realizing various kinds of functions as shown in FIG. 3, for instance, in addition to the telephone set dedicated for the IP telephone. Besides, the IP telephone is not limited to a fixed telephone, but may be the speaking terminal for mobile communications for speaking with voice by packet data communication, such as a cellular phone and a PHS (personal handy-phone system).

On the other hand, a network speaking control unit 80 as shown inside a frame with a broken line, comprising the quality evaluation equipment of network communication 1 together with the speaking terminal 3, 7, is connected with the communication network 2, as shown in FIG. 1. As shown in FIG. 4, the network speaking control unit 80 has a main control portion 81. A measuring point data collecting portion 82, a tone evaluation computing portion 83, a data memory 85, a quality analysis portion 86, a display portion 87, a communication control portion 88 connected with the communication network 2, an encoded data distributing portion 89 for recording voice data encoded in advance, a software distributing portion 90 for distributing the measuring software S1 and the like are connected with the main control portion 81 through a bus line 91.

The quality evaluation equipment of network speaking 1 has the above-mentioned structure. In order to speak with voice by packet data communication by the computer 3 connected with the communication network 2, a program for speaking, such as a softphone is first installed so that the computer 3 can function as the speaking portion 32 as shown in FIG. 2 (that is, the speaking terminal). It is not necessary newly install the program for speaking if the program for speaking is built in the computer 3 in advance.

Subsequently, in order to measure and compute speaking quality evaluation value described hereinafter by the computer 3 functioning as the speaking terminal, the measuring software S1 is downloaded from the software distributing portion 90 of the network speaking control unit 80 through the communication network 2 as shown in FIG. 1 so as to install so that the computer 3 can function as the speaking quality measurement portion 31 as shown in FIG. 2 (that is, the speaking quality monitoring unit 5 as shown in FIGS. 9(b) and (c)).

On this occasion, the program for measurement may have a program for speaking. In this case, the computer 3 can function as the speaking quality measurement portion 31 and the speaking portion 32 by installing only program for measurement having the program for speaking without installing the program for speaking, such as a softphone, in the computer 3.

On the other hand, the IP telephone 7 is in such a state that speaking with voice by packet data communication and measurement/computing of speaking quality evaluation value are possible since the telephone 7 has the speaking quality measurement portion 71 and the speaking portion 72 as shown in FIG. 3. On this occasion, the IP telephone having no speaking quality measurement portion 71 (that is, the IP telephone having only speaking function) may measure and compute speaking quality evaluation value by adding the function similar to the speaking quality measurement portion 71 to a hardware or a software.

As mentioned above, the quality evaluation equipment of network speaking 1 according to the present invention is provided with the speaking terminal 3, 7 having the speaking quality measurement portion 31, 71 for measuring and computing speaking quality evaluation value, as shown in FIG. 2 and FIG. 3, thereby making the structure simple, different from conventional quality evaluation equipment of network speaking 1x, 1y as shown in FIGS. 9(b) and (c) wherein a speaking quality monitoring unit 5 is provided between the communication network 2 and the speaking terminal

Besides, the speaking quality monitoring unit 5 is not connected upstream with respect to a communication system 50 as shown in the conventional quality evaluation equipment of network speaking 1y of FIG. 9(c). Therefore, a network speaking is not affected by an accident of the speaking quality monitoring unit 5 even if the structure upstream of the communication system 50 is made complex accompanied by rapid communication with optical fiber, so that the credibility of the network communication can be improved.

In case of speaking between the speaking terminals 3, 7 above-mentioned, voice data is transmitted onto the communication network 2 by the voice processing portion 18, 48 of the speaking portion 32, 72 in the speaking terminal 3, 7 on taking side, divided into voice packets each including many voice data (referred to as only “voice packet 6” hereinafter). When the voice data is transmitted, the data are generally encoded (compressed) with some codec (program for compression/extract) in order to decrease quantity of data to be transmitted. But, the voice data may be transmitted without encoding.

The IP address of the speaking terminal 3, 7 of the receiving side, to which voice data is transmitted, is stored in each voice packet 6 as destination information 6a. And, the speaking terminal 3, 7 gets the voice packet identification portion 13, 45 of the speaking quality measurement portion 31, 71 to watch the destination information 6a of the voice packet 6 flowing on the communication network 2 through the packet transmit-receive portion 12, 43, and identifies only voice packet 6 attaching the IP address thereon of the speaking terminal 3, 7 itself so as to instruct the packet transmit-receive portion 12, 43 to capture.

Then, telephone speaking is realized in such a manner that only voice packet 6 corresponding with own IP address is captured by the packet transmit-receive portion 12 in the computer 3 on the receiving side, and these voice packets 6 are decoded (restructured or extracted) by the voice processing portion 18 of the speaking portion 32, 72 so as to output to the head set 8, for instance, as voice signal. Besides, telephone speaking is realized in such a manner that only voice packet 6 corresponding with own IP address is captured by the packet transmit-receive portion 43 in the IP telephone 7 on the receiving side, and these voice packets 6 are decoded by the voice processing portion 48 so as to output to the voice input/output potion 42, such as a telephone receiver, as voice signal. That is, the operation processing for identification of the voice packet is executed on the speaking quality measurement portion 31, 71 side, not on the speaking portion 32, 72 side, so that duplication by both the speaking quality measurement portion 31, 71 and the speaking portion 32, 72 can be avoided.

On this occasion, many voice packets 6 transferred from the speaking terminal 3, 7 of the taking side are received by the speaking terminal 3, 7 of the receiving side via various routes on the communication network 2, thereby delay of reaching of the voice packet 6, jitter, disappearance of the voice packet 6 or the like occurs. Then, the speaking terminal 3, 7 on the receiving side obtains raw data every speaking quality parameter, such as data concerning delay of the reaching of the voice packet 6, jitter, disappearing of the voice packet 6, delay, reciprocating delay time, several kinds of objective tone evaluation values concerning the voice packet 6 of the speaking terminal 3, 7 on the receiving side received at the packet transmit-receive portion 12, 43 by the tone evaluation computing portion 15, 46 in the speaking quality measurement portion 31, 71 by a well-known method, and computes and measures the speaking quality evaluation value at that point of time by weighting or referring to a table from the raw data obtained, and registers it in the memory (not shown) together with its communicating register. On this occasion, the reciprocating delay time is measured between the speaking terminal 3, 7 of the taking side and the speaking terminal 3, 7 of the receiving side, and the objective tone evaluation value is computed and judged by decoding the voice packet 6.

Besides, it is necessary to voice by restructuring (decoding) voice data from the voice packet for any of the several kinds of the objective tone values in order to evaluate objective tone by the tone evaluation computing portion 15, 46. Since the voice packet has fluctuation (jitter) of reaching time, the processing for absorbing fluctuation in the actual speaking terminal 3, 7 is executed so as to voice. Accordingly, the tone evaluation computing portion 15, 46 is provided with the means for absorbing jitter, and when the speaking quality evaluation value is obtained, the fluctuation of the reaching time is absorbed by the means for absorbing jitter and the voice data is decoded so as to evaluate the objective tone on the basis of the voice data decoded. By doing so, the tone evaluation computing portion 15, 46 can compute and judge objective tone evaluation value, absorbing jitter, that is, on the basis of the voice data corresponding to the voice actually transferred to the receiving person with the speaking terminal 3, 7, and proper evaluation is possible.

There are several methods for absorbing of this fluctuation of the reaching time. For instance, the voice packet is held for a constant time and the processing is executed so as to restructure to such a degree that playing back is possible with original time later, thereby the influence of fluctuation can be softened and absorbed. Besides, it is preferable that the degree of absorbing fluctuation of the reaching time by the means for absorbing jitter at the time of computing objective tone evaluation value can be properly adjusted, fitting to the characteristic of the speaking terminal 3, 7.

The measurement and computing of the speaking quality evaluation value and the computing and judgment of the objective tone evaluation value can be effectively executed since the operation processing for identification of the voice packet is not executed by duplication of the speaking quality measurement portion 31, 71 and the speaking portion 32, 72, as mentioned above.

After the speaking quality evaluation value at the time of speaking concerning the specific computer 3 or the IP telephone 7 is measured and computed by the tone evaluation computing portion 15, 46 in this way, a scope producing portion (not shown) displays the speaking quality evaluation value computed and judged on the display portion 11, 41. Various kinds of forms, for instance, evaluation with four stages and a diagram, are thinkable as the display form of this speaking quality evaluation value (the details will be described hereinafter).

As mentioned above, it is necessary to encode voice data on the basis of some codec in order to transmit or receive the voice data. The quantity of computing on the processing for encoding voice data is generally larger than on the processing for decoding, and the load on (the CPU of) the speaking terminal 3, 7 is bigger thereby. On the other hand, the voice data at the time of speaking is comprised of various kinds of voice, then, it is difficult to separately compare various kinds of voice data so as to evaluate. Therefore, specific voice data (the style by the same person by the same language, for instance) is used for measurement and the specific voice data are compared with each other with time series so as to compute a correct objective tone evaluation value.

Then, the voice data encoded in advance to be used for measurement (referred to as “encoded data ED” hereinafter) is downloaded (delivered) from the encoded data distributing portion 89 of the network communication control unit 80 as shown in FIG. 4 through the communication network 2 as shown in FIG. 1 so as to record in the encoded data record portion 17 of the computer 3 as shown in FIG. 2.

When voice data is exchanged between the computer 3 and the network speaking control unit 80 or between the computers 3, 3 in order to compute objective tone evaluation value, the encoded data ED downloaded to the encoded data record portion 17 is transmitted as it is without encoding the voice data by the computer 3 so as to obtain the data for computing the objective tone evaluation value. By doing so, the burden accompanied by operation processing by the computer 3 can be decreased. Even if the computing performance of the computer 3 is low, objective tone evaluation value can be computed and judged without a problem.

On this occasion, the respective encoded data ED are prepared according to various kinds of codec in the encoded data distributing portion 89 so as to be free to be distributed, and the encoded data record portion 17 can download the encoded data ED corresponding to various kinds of codec according to its necessity. That is, the computer 3 to which various kinds of encoded data ED are downloaded in advance can obtain the raw data for measuring and computing the speaking quality evaluation value without encoding the voice data to be used for measurement concerning the voice speaking encoded by any codec.

The IP telephone 7 as shown in FIG. 3 does not have the function of downloading the encoded data ED. But, the telephone 7 can obtain the effect similar to the computer 3 in such a manner that a proper memory functions as the encoded data record portion 17 as shown in FIG. 2 and the function of downloading is added, similar to the computer 3.

In this way, each speaking terminal 3, 7 measures and computes speaking quality evaluation value and computes and judges objective tone evaluation value from the raw data obtained every speaking quality parameter, and transmits these speaking quality evaluation value and objective tone evaluation value (speaking quality evaluation data) to the network speaking control unit 80 as shown in FIG. 1.

In the network speaking control unit 80, the measuring point data collecting portion 82 communicates with each speaking terminal 3, 7 connected with the communication network 2 through the communication network 2 every predetermined time, so that the speaking quality evaluation data concerning the speaking monitored concerning each speaking terminal 3, 7 by each tone evaluation computing portion 15, 46 is collected so as to store in the data memory 85.

And, the objective tone evaluation value is computed and judged by the tone evaluation computing portion 83 in such a manner that if necessary or every predetermined time, reciprocating delay time is measured between the specific or all speaking terminals 3, 7, or the voice test data owned in advance by the speaking terminal 3, 7 and the network speaking control unit 80 are mutually exchanged so as to store the result in the data memory 85 as the speaking quality evaluation data. By doing so, the burden accompanied by operation processing on the speaking terminal 3, 7 can be decreased. Even if the computing performance of the speaking terminal 3, 7 is low, speaking quality evaluation value can be measured and computed and objective tone evaluation value can be computed and judged without a problem.

On this occasion, the network speaking control unit 80 as shown in FIG. 1 is connected with the speaking terminal 3, 7 through the communication network 2. But, it may be connected with the communication control portion 16, 47 of the speaking terminal 3, 7 through a dedicated line different from the communication network 2. In this case, the network speaking control unit 80 collects the speaking quality evaluation data from the communication control portion 16, 47 through the dedicated line. By doing so, the network speaking control unit 80 can certainly collect the speaking quality evaluation data in spite of the state of congestion of the communication network 2.

After the network speaking control unit 80 finishes collecting the speaking quality evaluation value concerning each speaking terminal 3, 7 from all speaking terminals 3, 7 connected with the communication network 2 at some point of time, the speaking quality of the whole communication network 2 at the point of time is evaluated on the basis of a predetermined evaluation standard by the quality analysis portion 86 from these evaluation values (The speaking quality of a part of the area comprised of a plurality of speaking terminals 3, 7 may be evaluated, not always of the whole communication network 2) so as to obtain the network speaking quality evaluation value, and the network speaking quality evaluation value obtained is displayed on the display portion 87.

If the network speaking quality evaluation value is lower than a predetermined threshold value and the quality of the voice speaking in the communication network 2 is lower than a predetermined standard, it is displayed on the display portion 87 and a network manager controlling the communication network 2 through the communication control portion 88 is notified of predetermined data, such as with an alarm and a report. These data may be a predetermined alarm signal. Then, the network manager can immediately perceive in which state the speaking quality of the present communication network 2 is.

As mentioned above, the speaking terminal 3, 7 is provided with the speaking quality measurement portion 31, 71 in the quality evaluation equipment of network speaking 1 according to the present invention, so that many speaking quality monitoring units 5 are not necessary to provide, which is different from the conventional quality evaluation equipment of network speaking 1x as shown in FIG. 9(b), and the structure of the quality evaluation equipment of network speaking can be made simple.

Besides, the operation processing for identification of the voice packet is not executed by duplication of the speaking quality measurement portion 31, 71 and the speaking portion 32, 72, so that the operation processing concerning the speaking quality evaluation data can be effectively executed and the network speaking quality evaluation value can be smoothly obtained.

On this occasion, the speaking quality evaluation data collected by the network speaking control unit 80 is not always the speaking quality evaluation value computed by each speaking terminal 3, 7, but may be raw data of the speaking quality parameter, such as data concerning delay of reaching of the voice packet 6, jitter, disappearing of the voice packet 6, reciprocating delay time, and several kinds of objective tone evaluation values concerning the speaking quality, which are the basis for computing the speaking quality evaluation value. Such raw data of the speaking quality parameter may be collected as the speaking quality evaluation data, and the speaking quality evaluation value and the objective tone evaluation value are computed on the basis of the raw data of the speaking quality parameter by the tone evaluation computing portion 83 of the network speaking control unit 80 so as to transmit the result computed to each speaking terminal 3, 7 by the communication control portion 88. By doing so, it is not necessary to make the structure of the speaking terminal 3, 7 complex, bigger load on the speaking terminal 3, 7 is not necessary so as to make the speaking terminal 3, 7 smaller and so as to decrease the load concerning the computing ability of the speaking terminal 3, 7. In this case, the speaking quality evaluation value on each speaking terminal 3, 7 may be computed so as to notify the speaking terminal 3, 7, if necessary. In this case, the notified speaking quality evaluation value is displayed on the display portion 11, 41 on the speaking terminal 3, 7 side.

And, the minimum value, the maximum value and the mean value of delay of reaching of the voice packet 6, jitter, reciprocating delay time, and objective tone evaluation value can be used as the speaking quality parameter, and number disappeared, length, rate of disappearing or time distribution of the disappearing of the packet 6 can be used as the parameter.

On this occasion, the instruction of evaluating and computing of the speaking quality may be input through a proper input means of the network speaking control unit 80, and the speaking quality evaluation data may be obtained from each speaking terminal 3, 7 at an optional time so as to compute the speaking quality concerning the communication network 2.

As mentioned above, operation processing can be effectively executed in the quality evaluation equipment of network speaking 1 according to the present invention although the structure is simple. The present invention is not limited to the above-mentioned embodiment, but can be also applied to an equipment having a switching hub in the communication network 2. First and second embodiments will now be explained concerning the quality evaluation equipment 1 having the switching hub hereinafter. In addition, a relation between an operating system, and a speaking program and a program for measurement will now be also explained in order to explain how to attain the above-mentioned effects in the relation with the operating system (OS) owned by the computer 3.

### First Embodiment

FIG. 5 is a schematic diagram for showing the quality evaluation equipment of speaking network 1a, 1b in first and second embodiments. In the quality evaluation equipment of speaking network 1a, 1b as shown in FIG. 5, only elements necessary for explanation are shown for simple explanation.

The quality evaluation equipment of speaking network 1a in the first embodiment has the communication network 2, similar to the quality evaluation equipment 1 as shown in FIG. 1. Communication systems 51, 52 are respectively constructed on the communication network 2 through lines V1, V2. The communication system 51 has computers 3A, 3B as the speaking terminal, and a server 80a as the network speaking control unit. On the other hand, the communication system 52 has IP telephones 7A, 7B as the speaking terminal. The explanation of the server 80a is omitted since the structure thereof is similar to one of FIG. 4.

In the communication system 51, the line V1 has lines V10, V11, V12 . . . . The communication network 2 is connected with one end of the line V10, and the other end of the line V10 is branched into the lines V11, V12, . . . by a plurality of ports owned by a switching hub 9_{V1}. And, the computer 3A is connected with the line V11, and the computer 3B is connected with the line V12. The head sets 8, 8 are respectively connected with the computers 3A, 3B, and a line C1, a dedicated line, for instance, different from the communication network 2 as shown in. FIG. 5, is connected with the computers 3A, 3B.

The line C1 has lines C11, C12, C13 and C14. The computer 3A is connected with one end of the line C11, and the switching hub 9_{C1} is connected with the other end of the line C11. Besides, the computer 3B is connected with one end of the line C12, and the switching hub 9_{C1} is similarly connected with the other end of the line C12. Furthermore, the server 80a is connected with the switching hub 9_{C1} through the line C13, and an outside memory 23a is connected with the server 80a through the line C14.

On the other hand, the line V2 has lines V20, V21, V22 in the communication system 52. The communication network 2 is connected with one end of the line V20, and the other end of the line V20 is branched into the lines V21, V22 by both ports owned by a switching hub 9_{V2}. And, the IP telephone 7A is connected with the line V21, and the IP telephone 7B is connected with the line V22. On this occasion, the above-mentioned lines V1, V2, C1 may be a wire or a wireless, and the communication systems 51, 52 may be constructed by wireless communications, such as a wireless LAN.

FIG. 6 is an explanatory drawing of the computer 3A, 3B in the first embodiment, (a) is a schematic configuration diagram, and (b) is a schematic block diagram.

The computer 3A, 3B stores an operating system (not shown) in a processor storage (not shown) of the computer 3A, 3B. Such an operating system is not limited to the operating system for providing GUI (graphical user interface) or various kinds of utility, such as OS for a personal computer, but may have basic functions, such as memory management and input-output management.

As shown in FIG. 6(a), the computer 3A, 3B has an OS control portion 25a connected with the line V1 for controlling the above-mentioned operating system, and an inside memory (such as a magnetic disc) 26a. The computer 3A, 3B functions as the speaking portion 32 connected with the OS control portion 25a by a CPU (not shown), for instance, by operating the speaking program, such as a softphone. Besides, the computer 3A, 3B functions as the speaking quality measurement portion 31 built in the OS control portion 25a by a CPU (not shown), for instance, by operating the measuring software S1.

Then, the speaking quality measurement portion 31 and the speaking portion 32 are connected with respect to the OS control portion 25a through bus lines 19A, 19B in parallel, as shown in FIG. 6(b). Furthermore, the display portion 11 is connected with the speaking quality measurement portion 31 through a bus line 19C. The speaking quality measurement portion 31 is comprised of a packet transmit-receive portion 12a connected with the OS control portion 25a through the bus line 19A, a voice packet identification portion 13a, the tone evaluation computing portion 15, the communication control portion 16 connected with the server 80a, and a quality display scope producing portion 20. And, the speaking portion 32 is comprised of a packet transmit-receive portion 12b connected with the OS control portion 25a through the bus line 19B, a voice packet identification portion 13b and the voice processing portion 18 connecting the head set 8 therewith.

As shown in FIGS. 6(a), (b), the head set 8 is connected with the speaking portion 32. With the speaking quality measurement portion 31, the inside memory 26a is connected, and the server 80a is connected through the line C1. Furthermore, the outside memory 23a is connected with the server 80a.

The quality evaluation equipment of network speaking 1a in the first embodiment has the above-mentioned structure. In order to speak with voice by packet data communication, the speaking program, such as a softphone, is installed in the computer 3A, 3B, so that the computer 3A, 3B functions as the speaking portion 32 connected with the OS control portion 25a, as shown in FIG. 6(a).

In order to measure and compute the speaking quality evaluation value with the computer 3A, 3B installing the speaking program therein, the measuring software S1 is downloaded from the software distributing portion 90 of the server 80a (the network speaking control unit) as shown in FIG. 4 through the lines C11, C12, and C13 so as to install in the computer 3A, 3B, so that the computer 3A, 3B functions as the speaking quality measurement portion 31 built in the OS control portion 25a, as shown in FIG. 6(a). That is, the measuring software S1 built in the OS control portion 25a functions as a device driver of the operating system, and the communication information to be transmitted and received by the speaking portion 32 through the OS control portion 25a can be read out.

In order to realize speaking between the communication system 52 and the communication system 51 in such a state that voice speaking by packet data communication is possible and the speaking quality evaluation value can be measured and computed by the computer 3A, 3B, a voice packet 6A with the IP address of the computer 3A is transmitted from the IP telephone 7A and a voice packet 6B with the IP address of the computer 3B is transmitted from the IP telephone 7B, as shown in FIG. 5, for instance.

As shown in FIG. 5, the voice packet 6A transmitted is transmitted on the communication network 2 through the line V21, the switching hub 9_{V2} and the line V20, and the voice packet 6B transmitted is transmitted on the communication network 2 through the line V22, the switching hub 9_{V2} and the line V20, similar to the voice packet 6A.

In the voice packet 6A, 6B, MAC (Media Access Control) address is stored, in addition to the above-mentioned IP address. This MAC address is a specific address allocated to the respective speaking terminals comprising a LAN in the LAN comprised of the communication system 51, for instance.

The switching hub has a function of identifying the communication information including MAC address of each speaking terminal connected with each port of the switching hub from among various kinds of the communication information transmitted from the communication network 2, such as voice data, image data, and WWW data, and of transmitting every corresponding speaking terminal.

That is, the switching hub 9_{V1} discriminates the communication information including the MAC address of the computer 3A, 3B from among the various communication information transmitted from the communication network 2. Then, the switching hub 9_{V1} discriminates the communication information concerning the computer 3A, 3B from the MAC address stored in the voice packet 6A, 6B transmitted to the communication network 2, and transmits the voice packet 6A, 6B to the computer 3A, 3B. When the communication information including the MAC address of the computer 3A, 3B is transmitted, the information is similarly transmitted to the computer 3A, 3B in order.

On the other hand, the voice packet identification portion 13b of the speaking portion 32 in the computer 3A, 3B watches the communication information transmitted from the switching hub 9_{V1} through the line V11, V12. Then, the voice packet identification portion 13b discriminates the voice packet 6A, 6B as the voice packet attaching own IP address thereon from among the communication information concerning the computer 3A, 3B transmitted from the switching hub 9_{V1}.

That is, it is not necessary for the voice packet identification portion 13b to discriminate the target voice packet from among the various communication information as the conventional quality evaluation equipment of network speaking 1y as shown in FIG. 9(c) since the portion 13b discriminates the target voice packet from among the communication information concerning the computer 3A, 3B, so that the voice packet identification portion 13b can easily discriminate the voice packet attaching own IP address thereon.

When the voice packet attaching own IP address thereon is discriminated by the voice packet identification portion 13b in this way, the packet transmit-receive portion 12b of the speaking portion 32 is instructed to capture. Then, the packet transmit-receive portion 12b of the speaking portion 32 captures the voice packet 6A, 6B attaching own IP address thereon through the OS control portion 25a, and the voice processing portion 18 of the speaking portion 32 decodes (restructures, extracts) the voice packet 6A, 6B so as to output to the head set 8, for instance, as voice signal. In this way, speaking between the computer 3A and the IP telephone 7A or between the computer 3B and the IP telephone 7B is realized.

On the other hand, the voice packet identification portion 13a of the speaking quality measurement portion 31 also watches the voice packet, similar to the voice packet identification portion 13b of the speaking portion 32, and discriminates the voice packet attaching own IP address thereon. On this occasion, the voice packet identification portion 13a can easily discriminate the voice packet 6A, 6B attaching own IP address thereon since the communication information to be transmitted and received by the speaking portion 32 through the OS control portion 25a from the speaking quality measurement portion 31 can be read out, as mentioned above. Besides, such communication information is discriminated by the switching hub 9_{V1}, similar to the above-mentioned, so that the voice packet identification portion 13a of the speaking quality measurement portion 31 can discriminate the voice packet 6A, 6B from among the communication information transmitted and received more easily.

In this way, the voice packet identification portion 13a of the speaking quality measurement portion 31 discriminates the voice packet 6A, 6B attaching own IP address thereon, and the packet transmit-receive portion 12a of the speaking quality measurement portion 31 is instructed to capture the voice packet 6A, 6B. Then, the packet transmit-receive portion 12a captures the voice packet 6A, 6B, and the raw data every speaking quality parameter, such as delay of reaching, jitter, disappearing of the voice packet 6A, 6B, delay, reciprocating delay time, several kinds of objective tone evaluation values is obtained by the tone evaluation computing portion 15 in the speaking quality measurement portion 31 as mentioned above, and the jitter is absorbed by the means for absorbing jitter provided in the tone evaluation computing portion 15 so as to decode the voice data 6A, 6B. In this way, the objective tone evaluation value is computed and judged.

The speaking quality evaluation value can be effectively measured and computed or the objective tone evaluation value can be effectively computed and judged since the voice packet 6A, 6B attaching own IP address thereon can be easily discriminated by the voice packet identification portion 13a, as mentioned before.

After the tone evaluation computing portion 15 in the speaking quality measurement portion 31 obtains the raw data concerning the voice packet 6A, 6B, the speaking quality evaluation value at this point of time is measured and computed with weighting or a table on the basis of the raw data obtained so as to record in the inside memory 26a as shown in FIG. 6(a). And, the speaking quality evaluation value is evaluated with four stages, for instance, using the above-mentioned weighting or a table, and the quality display scope producing portion 20 in the speaking quality measurement portion 31 is instructed to produce a quality display scope EPa for showing the evaluation result. Then, the quality display scope producing portion 20 produces the quality display scope EPa so as to display an image PCa on which the quality display scope EPa produced is located on a predetermined place on the display portion 11, such as a display, as shown in FIG. 7(a).

FIG. 7 is a drawing for showing an example of a scope on a display, (a) is a drawing for showing an example of a scope EPa displaying quality in the first embodiment, and (b) is a drawing for showing an example of a scope EPb displaying quality in the second embodiment. The quality display scope EPa is displayed as a status bar concerning the result of evaluation of the speaking quality evaluation value, as shown in FIG. 7(a).

In the concrete, a quality display button EPa1 for showing “ON” or “OFF”, through which the result of evaluation can be selectively displayed by an icon, such as a mouse pointer, is provided on the right hand of the quality display scope EPa in the figure. “ON” for displaying the evaluation result is selected on the quality display button EPa1 as shown in FIG. 7(a).

On the left hand of the quality display scope EPa in the figure, a quality display portion EPa2 for displaying the evaluation result of the speaking quality evaluation value is provided. Any of “⊚”, “◯”, “Δ” or “X” is displayed on the quality display portion EPa2 in order from good evaluation result according to the evaluation result in evaluation with four stages, for instance. Besides, “?” is displayed if there is no speaking quality evaluation value to be evaluated, such as if the speaking quality evaluation value is not recorded in the inside memory 26a. All evaluation result of “⊚”, “∘”, “Δ”, “X”, “?” is displayed on the quality display portion EPa2 as shown in FIG. 7(a) for convenience of explanation.

If “ON” is displayed on the quality display button EPa1 in the computer 3A, for instance (that is, if evaluation result is displayed), the quality display scope producing portion 20 produces the quality display scope EPa for showing the evaluation result of the speaking quality evaluation value concerning the speaking between the computer 3A and the IP telephone 7A so as to display on the display portion 11, such as a display.

On this occasion, the quality display scope EPa as shown in FIG. 7(a) is only an instance, so the scope EPa can be variously transformed as long as the evaluation result of the speaking quality evaluation value can be displayed. A picture utilizing various kinds of graphs, a still picture, a moving picture or voice, for instance, may be output.

By doing so, the speaking quality of the voice actually heard by a user and the above-mentioned evaluation result displayed on the quality display scope EPa can be compared with each other. When the speaking quality of the voice actually heard is not good and “X” for showing a poor state is displayed on the quality display scope EPa, for instance, this state can be informed of a manager of a network business on the basis of the subjective evaluation result with respect to the voice actually heard by a user and the objective evaluation result displayed on the quality display scope EPa, and then, the person can effectively specify the reasons of the quality deterioration of the voice speaking.

Besides, a user changes a connection opponent and the communication network 2, watching the evaluation result displayed on the quality display scope EPa, so that the user can check a route of the communication network 2 where quality in voice speaking is good. By doing so, the user can change into the route of the communication network 2 where quality in voice speaking is good so as to speak.

After finishing the speaking between the IP telephones 7A, 7B and the computers 3A, 3B, the tone evaluation computing portion 15 of the speaking quality measurement portion 31 in the computer 3A, 3B transmits the data for evaluating speaking quality comprised of the value for evaluating speaking quality or the objective tone evaluation value to the server 80a through the communication control portion 16 via the line C1 different from the line V1. The measuring point data collecting portion 82 (see FIG. 4) of the server 80a collects the transmitted data for evaluating speaking quality so as to store in the data memory 85 (see FIG. 4).

That is, the data for evaluating speaking quality can be certainly transmitted on the line C1 regardless of the congestion state of the communication network 2 since the communication network 2 does not intervene in the line C1. On this occasion, it is not always necessary to transmit the data for evaluating the speaking quality to the server 80a every speaking, but these data may be collectively transmitted in the time zone when speaking frequency is low, such as at night.

If the voice quality is irregularly deteriorated, communication is regularly executed between both computers 3A, 3B or the server 80a with the same measuring function so as to obtain raw data every speaking quality parameter, so that the evaluation value of the speaking quality measured and computed with the raw data may be transmitted to the server 80a. By doing so, the reasons for deterioration of the voice speaking in its quality can be easily specified even if it is difficult to specify the reasons of the deterioration owing to irregular deterioration of the speaking quality.

In this way, speaking is executed between each computer 3A, 3B and a plurality of another speaking terminals, such as the IP telephones 7A, 7B, and the tone evaluation computing portion 15 of the speaking quality measurement portion 31 in the computer 3A, 3B measures and computes the evaluation value of the speaking quality or computes and judges the objective tone evaluation value so as to transmit the evaluation data of speaking quality to the server 80a. As mentioned before, the voice packet 6A, 6B attaching own IP address thereon is easily identified by the voice packet identification portion 13a and the arithmetic processing concerning the evaluation data of the speaking quality is effectively executed by the tone evaluation computing portion 15, so that the evaluation data of the speaking quality is smoothly transmitted to the server 80a.

On this occasion, the measurement and computing of the evaluation value of the speaking quality or the computing and judgment of the objective tone evaluation value is not always necessary to be executed by the speaking terminal, but the computing may be executed by the tone evaluation computing portion 83 of the server 80a so as to transmit the result computed to each speaking terminal by the communication control portion 88. By doing so, the burden on the speaking terminal by the arithmetic processing can be decreased, and quality display images EPa, EPb can be smoothly displayed when the quality display scope producing portion 20 produces the quality display images EPa, EPb, for showing the evaluation value of speaking quality or the objective tone evaluation value.

And, the quality analysis portion 86 (see FIG. 4) of the server 80a judges and evaluates the speaking quality evaluation value of the network on the basis of the data for evaluating the speaking quality so as to register in the outside memory 23a as data base. When the evaluation value of the network speaking quality is lower than a predetermined threshold value, this state is displayed on the display portion 87 and a manager of network business is informed of predetermined data with alarm or report, for instance, through the communication control portion 88, as already mentioned. By doing so, the manager of network business can immediately recognize in which state the speaking quality of the present communication network 2 is.

As explained above, in the quality evaluation equipment of network speaking la according to the present invention, the communication information concerning the computer 3A, 3B is identified by the switching hub 9_{V1}, so that the voice packet 6A, 6B attaching own IP address thereon can be easily identified by the voice packet identification portion 13a. Therefore, arithmetic processing concerning the evaluation data of the speaking quality can be more effectively executed, so that the quality evaluation value of network speaking can be smoothly obtained.

The speaking terminal of the quality evaluation equipment of network speaking 1a in the above-mentioned first embodiment is the computer 3A, 3B. But, the speaking terminal is not limited to the computer 3A, 3B as long as the speaking terminal has the OS control portion 25a in which the speaking quality measurement portion 31 can be built. For instance, the IP telephone 7 is available as long as it has an operating system to be used for a cellular phone or a home appliance, such as a built-in OS, and the speaking quality measurement portion can be build in the OS control portion capable of controlling the operating system.

### Second Embodiment

Subsequently, the quality evaluation equipment of speaking network 1b in the second embodiment will now be explained. As explained before, the quality evaluation equipment of speaking network 1b in the second embodiment as shown in FIG. 5 is almost similar to the quality evaluation equipment of speaking network 1a in the first embodiment. So, the explanation of the part similar to one of the first embodiment is omitted hereinafter.

FIG. 8 is an explanatory drawing of the computer 3A, 3B in the second embodiment, (a) is a schematic configuration diagram, and (b) is a schematic block diagram. Only elements necessary for explanation are shown in the computer 3A, 3B as shown in FIG. 8(a) for easy explanation.

Similar to the first embodiment, an operating system (not shown) is stored in a main storage unit (not shown) of the computer 3A, 3B. And, the computer 3A, 3B has an OS control portion 25b to be controlled by the operating system, which is connected with the line V1, as shown in FIG. 8(a).

The software distributing portion 90 of a server 80b as shown in FIG. 4 (the network speaking control unit) is free to distribute a program for measurement having a speaking program (referred to as “speaking measuring software S2” hereinafter). Then, the computer 3A, 3B functions as the speaking quality measurement portion 31 connected with the OS control portion 25b, and the speaking portion 32 which is built in the speaking quality measurement portion 31 by a CPU (not shown) as shown in FIG. 8(a) in such a way that the speaking measuring software S2 is downloaded from the software distributing portion 90 so as to install in the computer 3A, 3B.

Therefore, the speaking quality measurement portion 31 and the speaking portion 32 are connected with each other through the bus line 19, as shown in FIG. 8(b). The speaking quality measurement portion 31 is comprised of the packet transmit-receive portion 12 connected with the OS control portion 25b, the voice packet identification portion 13, the tone evaluation computing portion 15, and the communication control portion 16 connected with the server 80b. And, the speaking portion 32 is comprised of the voice processing portion 18, an operation scope producing portion 22 and a call transmit-receive portion 21. Furthermore, the voice processing portion 18 is connected with the tone evaluation computing portion 15 of the speaking quality measurement portion 31.

The quality evaluation equipment 1b in the second embodiment has the above-mentioned structure. In order to speak with voice by packet data communication and to measure and compute the evaluation value of speaking quality, the speaking measuring software S2 is downloaded from the software distributing portion 90 of the server 80b as shown in FIG. 4 (the network speaking control unit) through the line C1 so as to install in the computer 3A, 3B, so that the computer 3A, 3B functions as the speaking quality measurement portion 31 connected with the OS control portion 25b and the speaking portion 32 built in the speaking quality measurement portion 31 by a CPU (not shown) for instance, as shown in FIG. 8(a).

Supposing that the voice packet 6A, 6B having the IP address of the computer 3A, 3B is transmitted onto the communication network 2 from the IP telephone 7A, 7B as shown in FIG. 5 in the above-mentioned state, similar to the quality evaluation equipment of speaking network 1b in the first embodiment.

Similar to the first embodiment, the switching hub 9_{V1} identifies the communication information concerning the computer 3A, 3B by the MAC address stored in the voice packet 6A, 6B, which is transmitted onto the communication network 2 so as to transmit the communication information concerning the computer 3A, 3B, such as the voice packet 6A, 6B to the computer 3A, 3B. Then, the voice packet identification portion 13 of the speaking quality measurement portion 31 in the computer 3A, 3B identifies the voice packet 6A, 6B as the voice packet attaching own IP address thereon from among the communication information concerning the computer 3A, 3B, which is transmitted from the switching hub 9_{V1}. By doing so, the voice packet identification portion 13b can easily identify the voice packet 6A, 6B attaching the own IP address thereon, similar to the first embodiment.

After the voice packet 6A, 6B is identified as the voice packet attaching the own IP address thereon by the voice packet identification portion 13 of the speaking quality measurement portion 31 in this way, the call transmit-receive processing portion 21 of the speaking portion 32 is instructed to process for call receiving. Then, the call transmit-receive processing portion 21 of the speaking portion 32 executes the process for call receiving.

Each call transmit-receive processing portion 21 firstly instructs the operation scope producing portion 22 of the speaking portion 32 to produce an operation scope CP through which operation concerning call receiving or call transmission is possible. Then, the operation scope producing portion 22 produces the operation scope CP so as to display an image PCb on which the operation scope CP produced is located at a predetermined position on the display portion 11, such as a display, as shown in FIG. 7(b).

The display scope EPb (in a dashed line), similar to one of the first embodiment explained with FIG. 7(a) is provided on the upper hand of the operation scope CP in the figure, enabling evaluation result of the evaluation value of the speaking quality to be displayed thereon (will be explained in detail hereinafter). On the operation scope CP (in a broken line), a number display portion CP1 for displaying the number input, a plurality of number input buttons CP2, comprised of the numbers which can be input, such as “1”, “2”, “3” . . . , a call transmit-receive button CP3, through which call receiving or call transmission can be instructed, on which “CALL RECEIVING, CALL TRANSMISSION” is displayed in the figure, and a speaking finish button CP4, through which speaking finish can be instructed, on which “OFF” is shown in the figure, are provided in order from the upper hand in the figure. These buttons CP2, CP3, CP4 are free to be pressed with an icon, such as a mouse pointer. On this occasion, such operation scope CP may be displayed in the quality evaluation equipment of speaking network la in the first embodiment.

In case of call transmission from the computer 3A, 3B side, for instance, the number input buttons CP2 corresponding to a predetermined telephone number are pressed, so that the numbers pressed can be displayed on the number display portion CP1 in order. When predetermined numbers are input as a telephone number and the call transmit-receive button CP3 is pressed, the call transmit-receive processing portion 21 executes the process for call transmission so as to transmit a predetermined voice signal onto the communication network 2. When the voice packet attaching own IP address thereon is identified by the voice packet identification portion 13, the above-mentioned process for call receiving is executed and a user is informed of call receiving by the call transmit-receive processing portion 21 of the speaking portion 32 by a predetermined call receiving sound or flashing of the call transmit-receive button CP3.

When the call transmit-receive button CP3 is pressed in the above-mentioned state, the voice packet identification portion 13 is instructed to speak and the voice packet identification portion 13 instructs the packet transmit-receive portion 12 to capture the voice packet. Then, the packet transmit-receive portion 12 captures the voice packets 6A, 6B each attaching own IP address thereon through the OS control portion 25b, and the tone evaluation computing portion 15 obtains raw data every speaking quality parameter, similar to the quality evaluation equipment of speaking network 1a in the first embodiment. Concerning the objective tone evaluation, jitter is absorbed by the means for absorbing jitter, providing the tone evaluation computing portion 15 so as to decode the voice data 6A, 6B. Then, the objective tone evaluation value is computed and judged.

On this occasion, the tone evaluation computing portion 15 outputs the decoded voice data 6A, 6B to the voice processing portion 18 connected with the tone evaluation computing portion 15, as shown in FIG. 8(b), and the voice processing portion 18 immediately outputs the voice data already decoded to the head set 8, for instance, as the voice signal so as to realize speaking.

That is, the voice processing portion 18 can output voice on the basis of the voice data decoded by the means for absorbing jitter of the tone evaluation computing portion 15 by building the speaking portion 32 in the speaking quality measurement portion 31. Therefore, the arithmetic processing concerning decoding is not necessary, and the arithmetic processing concerning the evaluation data of the speaking quality can be more effectively executed.

After the tone evaluation computing portion 15 in the speaking quality measurement portion 31 obtains the raw data concerning the voice packet 6A, 6B in this way, the evaluation value of speaking quality at the point of time is measured and computed from the raw data obtained with weighting or a table so as to register in a memory (not shown), and the evaluation value of the speaking quality is evaluated with the above-mentioned weighting or a table, such as evaluation with four stages, so as to display the evaluation result of the evaluation value of the speaking quality on the quality display scope EPb on the operation scope CP already displayed as shown in FIG. 7(b).

The quality display scope EPb is similar to the quality display scope EPa as shown in FIG. 7(a). A quality measurement display button EPb1 for selectively displaying the evaluation result with an icon, such as a mouse pointer, is provided on the right hand of the quality display scope EPb in the figure. And, a quality display portion EPb2 for displaying the evaluation result of the evaluation value of speaking quality, with “⊚”, “◯”, “Δ” and “X”, is provided on the left hand of the quality display scope EPb in the figure.

That is, the evaluation result on the quality display scope EPb can be simultaneously displayed during speaking since the voice data already decoded by the means for absorbing jitter of the tone evaluation computing portion 15 is immediately output as a voice signal, as mentioned before.

In this way, the tone evaluation computing portion 15 of the speaking quality measurement portion 31 in the computer 3A, 3B measures and computes the evaluation value of speaking quality or computes and judges the objective tone evaluation value, similar to the first embodiment. When the speaking between the IP telephone 7A, 7B and the computer 3A, 3B finishes, the tone evaluation computing portion 15 of the speaking quality measurement portion 31 transmits the evaluation data of speaking quality, comprised of the evaluation value of speaking quality and the objective tone evaluation value, to the server 80b. As already mentioned, it is not necessary for the voice processing portion 18 to execute arithmetic process concerning decoding, and the arithmetic processing concerning the evaluation data of speaking quality is more effectively executed by the tone evaluation computing portion 15, so that the evaluation data of the speaking quality can be smoothly transmitted to the server 80a.

And, the quality analysis portion 86 (see FIG. 4) of the server 80b judges and evaluates the evaluation value of the speaking quality of network on the basis of the evaluation data of speaking quality so as to register in an outside memory 23b as data base. When the evaluation value of the quality of the network speaking is lower than a predetermined threshold value, this state is displayed on the display portion 87 and a network manager is informed of predetermined data with alarm or report through the communication control portion 88.

In the quality evaluation equipment of network speaking 1b according to the present invention, the switching hub 9_{V1} identifies the communication information concerning the computer 3A, 3B, and the voice processing portion 18 of the speaking portion 32 immediately outputs the voice data already decoded by the means for absorbing jitter of the tone evaluation computing portion 15 as a voice signal, so that the arithmetic processing concerning the evaluation data of speaking quality can be more effectively executed. By doing so, the evaluation value of the quality of the network speaking can be more smoothly obtained.

The present invention is explained on the basis of the embodiments heretofore. The embodiments which are described in the present specification are illustrative and not limiting. The scope of the invention is designated by the accompanying claims and is not restricted by the descriptions of the specific embodiments. Accordingly, all the transformations and changes belonging to the claims are included in the scope of the present invention.

1. Quality evaluation equipment of network speaking for evaluation of speaking quality of network speaking, comprising:
means for voice speaking for speaking with voice with voice packets through a communication network, and means for measuring and computing speaking quality, for measuring and computing data for evaluating speaking quality concerning said voice speaking by said means for voice speaking, both provided at a speaking terminal;
a network speaking control unit connected with said speaking terminal; and
said network speaking control unit having means for collecting data for evaluating speaking quality, for collecting data for evaluating speaking quality measured and computed by said means for measuring and computing speaking quality of each said speaking terminal.

2. The quality evaluation equipment of network speaking according to claim 1, wherein said means for measuring and computing speaking quality of each said speaking terminal has means for identifying voice packet, for identifying said voice packet of voice speaking executed by said means for voice speaking from communication information through said communication network, and means for receiving voice packet, for receiving said voice packet identified by said means for identifying voice packet, wherein speaking with voice is executed by said means for voice speaking with said voice packet received from said means for receiving voice packet.

3. The quality evaluation equipment of network speaking according to claim 2, wherein a plurality of said speaking terminals are connected with said communication network through means for identifying and transmitting communication information, said means for identifying and transmitting communication information has means for identifying communication information, for identifying said communication information concerning each said speaking terminal connected with said means for identifying and transmitting communication information from said communication information through said communication network, and means for transmitting communication information, for transmitting said communication information identified by said means for identifying communication information to said corresponding speaking terminal, wherein said means for identifying voice packet of each said speaking terminal identifies said voice packet of voice speaking to be executed by said means for voice speaking from said communication information transmitted by said means for transmitting communication information connecting said speaking terminal therewith.

4. The quality evaluation equipment of network speaking according to claim 1, wherein said network speaking control unit has means for judging quality of network speaking, for computing and judging said speaking quality of network speaking on the basis of said data for evaluating speaking quality collected by said means for collecting data for evaluating speaking quality.

5. The quality evaluation equipment of network speaking according to claim 1, wherein said network speaking control unit has means for storing data for evaluating speaking quality, for storing said data for evaluating speaking quality collected by said means for collecting data for evaluating speaking quality.

6. The quality evaluation equipment of network speaking according to claim 1, wherein said network speaking control unit can be connected with said speaking terminal through a line different from said communication network.

7. The quality evaluation equipment of network speaking according to claim 1, wherein said network speaking control unit has means for distributing encoded data, for distributing encoded data obtained by encoding said voice data to be used for measurement to each said speaking terminal, wherein said means for measuring and computing speaking quality of each said speaking terminal can compute said data for evaluating speaking quality on the basis of said encoded data distributed by said means for distributing encoded data.

8. The quality evaluation equipment of network speaking according to claim 1, wherein said data for evaluating speaking quality includes at least one data of data of jitter, disappearing, delay, reciprocating delay time, objective tone evaluation value concerning said voice packet, to be measured and computed by said means for measuring and computing speaking quality.

9. The quality evaluation equipment of network speaking according to claim 8, wherein said network speaking control unit has means for computing speaking quality, for computing evaluation value of speaking quality or objective tone evaluation value concerning each said speaking terminal on the basis of said data collected by said means for collecting data for evaluating speaking quality.

10. The quality evaluation equipment of network speaking according to claim 9, wherein said network speaking control unit has means for transmitting data for evaluating speaking quality, for transmitting evaluation value of speaking quality or objective tone evaluation value concerning each said speaking terminal computed by said means for computing speaking quality to each said speaking terminal, said speaking terminal has means for producing image for displaying quality, for producing image for displaying quality for displaying said evaluation value of speaking quality or said objective tone evaluation value transmitted by said means for transmitting data for evaluating speaking quality, and display means, for displaying said image for displaying quality produced by said means for producing image for displaying quality.

11. The quality evaluation equipment of network speaking according to claim 1, wherein said means for measuring and computing speaking quality of each said speaking terminal has means for judging speaking quality, for judging speaking quality at the time of speaking on the basis of said data for evaluating speaking quality, and said speaking terminal has means for producing image for displaying quality, for producing image displaying quality for displaying speaking quality at the time of speaking judged by said means for judging speaking quality, and display means, for displaying image for displaying quality produced by said means for producing image for displaying quality.

12. The quality evaluation equipment of network speaking according to claim 1, wherein said means for measuring and computing speaking quality of each said speaking terminal has means for decoding voice packet, for decoding said voice packet through said communication network, and said means for measuring and computing speaking quality is provided with said means for voice speaking such that speaking with voice is possible on the basis of said voice packet decoded by said means for decoding voice packet.

13. The quality evaluation equipment of network speaking according to claim 11, wherein said means for decoding voice packet has means for absorbing jitter and decoding, for absorbing jitter concerning said voice packet through said communication network and for decoding said voice packet where jitter is absorbed, and said means for measuring and computing speaking quality has means for computing objective tone evaluation value, for computing said objective tone evaluation value on the basis of said voice packet decoded by said means for absorbing jitter and decoding.

14. Quality evaluation equipment of network speaking for evaluation of speaking quality of network speaking, comprising:
unit for voice speaking for speaking with voice with voice packets through a communication network, and unit for measuring and computing speaking quality, for measuring and computing data for evaluating speaking quality concerning said voice speaking by said unit for voice speaking, both provided at a speaking terminal;
a network speaking control unit connected with said speaking terminal; and
said network speaking control unit having unit of collecting data for evaluating speaking quality, for collecting data for evaluating speaking quality measured and computed by said unit for measuring and computing speaking quality of each said speaking terminal.

15. The quality evaluation equipment of network speaking according to claim 14, wherein said unit for measuring and computing speaking quality of each said speaking terminal has unit for identifying voice packet, for identifying said voice packet of voice speaking executed by said unit for voice speaking from communication information through said communication network, and unit for receiving voice packet, for receiving said voice packet identified by said unit of identifying voice packet, wherein speaking with voice is executed by said unit for voice speaking with said voice packet received from said unit for receiving voice packet.

16. The quality evaluation equipment of network speaking according to claim 15, wherein a plurality of said speaking terminals are connected with said communication network through unit for identifying and transmitting communication information, said unit for identifying and transmitting communication information has unit for identifying communication information, for identifying said communication information concerning each said speaking terminal connected with said unit for identifying and transmitting communication information from said communication information through said communication network, and unit for transmitting communication information, for transmitting said communication information identified by said unit for identifying communication information to said corresponding speaking terminal, wherein said unit for identifying voice packet of each said speaking terminal identifies said voice packet of voice speaking to be executed by said unit for voice speaking from said communication information transmitted by said unit for transmitting communication information connecting said speaking terminal therewith.

17. The quality evaluation equipment of network speaking according to claim 14, wherein said network speaking control unit has unit for judging quality of network speaking, for computing and judging said speaking quality of network speaking on the basis of said data for evaluating speaking quality collected by said unit for collecting data for evaluating speaking quality.

18. The quality evaluation equipment of network speaking according to claim 14, wherein said network speaking control unit has unit for storing data for evaluating speaking quality, for storing said data for evaluating speaking quality collected by said unit for collecting data for evaluating speaking quality.

19. The quality evaluation equipment of network speaking according to claim 14, wherein said network speaking control unit can be connected with said speaking terminal through a line different from said communication network.

20. The quality evaluation equipment of network speaking according to claim 14, wherein said network speaking control unit has unit for distributing encoded data, for distributing encoded data obtained by encoding said voice data to be used for measurement to each said speaking terminal, wherein said unit for measuring and computing speaking quality of each said speaking terminal can compute said data for evaluating speaking quality on the basis of said encoded data distributed by said unit for distributing encoded data.

21. The quality evaluation equipment of network speaking according to claim 14, wherein said data for evaluating speaking quality includes at least one data of data of jitter, disappearing, delay, reciprocating delay time, objective tone evaluation value concerning said voice packet, to be measured and computed by said unit for measuring and computing speaking quality.

22. The quality evaluation equipment of network speaking according to claim 21, wherein said network speaking control unit has unit for computing speaking quality, for computing evaluation value of speaking quality or objective tone evaluation value concerning each said speaking terminal on the basis of said data collected by said unit for collecting data for evaluating speaking quality.

23. The quality evaluation equipment of network speaking according to claim 22, wherein said network speaking control unit has unit for transmitting data for evaluating speaking quality, for transmitting evaluation value of speaking quality or objective tone evaluation value concerning each said speaking terminal computed by said unit for computing speaking quality to each said speaking terminal, said speaking terminal has unit for producing image for displaying quality, for producing image for displaying quality for displaying said evaluation value of speaking quality or said objective tone evaluation value transmitted by said unit for transmitting data for evaluating speaking quality, and display unit, for displaying said image for displaying quality produced by said unit for producing image for displaying quality.

24. The quality evaluation equipment of network speaking according to claim 14, wherein said unit for measuring and computing speaking quality of each said speaking terminal has unit for judging speaking quality, for judging speaking quality at the time of speaking on the basis of said data for evaluating speaking quality, and said speaking terminal has unit for producing image for displaying quality, for producing image displaying quality for displaying speaking quality at the time of speaking judged by said unit for judging speaking quality, and display unit, for displaying image for displaying quality produced by said unit for producing image for displaying quality.

25. The quality evaluation equipment of network speaking according to claim 14, wherein said unit for measuring and computing speaking quality of each said speaking terminal has unit for decoding voice packet, for decoding said voice packet through said communication network, and said unit for measuring and computing speaking quality is provided with said unit for voice speaking such that speaking with voice is possible on the basis of said voice packet decoded by said unit for decoding voice packet.

26. The quality evaluation equipment of network speaking according to claim 24, wherein said unit for decoding voice packet has unit for absorbing jitter and decoding, for absorbing jitter concerning said voice packet through said communication network and for decoding said voice packet where jitter is absorbed, and said unit for measuring and computing speaking quality has unit for computing objective tone evaluation value, for computing said objective tone evaluation value on the basis of said voice packet decoded by said unit for absorbing jitter and decoding.
